(19) United States
(12) Patent Application Publication
(10) Pub. No.: US 2004/0197458 A1
(43) Pub. Date: Oct. 7, 2004

(54) Gelled foods

(75) Inventors: Rodney O. Nuckles, Vernon, CA (US); Candy K. York, Vernon, CA (US)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA

(21) Appl. No.: 10/785,570

(22) Filed: Feb. 24, 2004

Related U.S. Application Data
(63) Continuation-in-part of application No. 10/373,122, filed on Feb. 24, 2003.

(51) Int. Cl. A23L 1/05

(52) U.S. Cl. 426/573

(57) ABSTRACT

A process for preparing gelled food products comprising the steps of (a) preparing food materials and ingredients to form a food product; (b) preparing a gelling agent to form a gelling solution; (c) dipping the food product in the gelling solution, enrobing the food product with the gelling solution or adding the gelling solution to the food product; and (d) cooling the food product and gelling solution, wherein a gelled food product is formed.

### CROSS REFERENCE TO RELATED APPLICATIONS

This application is a continuation-in-part of U.S. Ser. No. 10/373,122 filed on Feb. 24, 2003 which is incorporated herein in its entirety.

### TECHNICAL FIELD

The invention relates to non-shelf stable gelled food products and a process for the preparation of gelled food products, more specifically gelled, portioned frozen or cold stored food products.

### BACKGROUND OF THE INVENTION

Gel have been used to coat some food products. Seafood, meat, poultry, vegetables, cheese and dough products in order to increase shelf life and improve product integrity However, these gels have been designed to maintain their gel structure and not melt, degrade or break the gel structure bonds through cooking. The prior art gels have been used to coat meats to preserve quality and to hold batter/bread crumbs to food through the frying process. However, gels have not been used to provided a method to maintain individual portions of products together, which upon heating, break apart and provide a liquid sauce for consumption.

There is a need for a simple and fast way to prepare and serve individual portions of good, fresh tasting foods. Of particular interest are fresh vegetables, meats, grains and pastas that have a fresh cooked taste and texture and finished in a sauce or gravy. Rapid preparation of these foods is difficult and usually avoided in today's fast paced environment. When there is a need to prepare multiple servings of sauce and/or food products served in conjunction with the sauce, it is currently only practical to make sauce and/or food products from scratch in one batch. Frozen or refrigerated food products are available but are usually packed in single serve containers for retail sale or multiserving containers for food service establishments, as large qualities of single serve containers for a restaurant type setting would not be cost feasible. The multiserving containers require the food to be prepared well in advance and kept hot until serving, or to be re-heated at serving time. Constant heat and cycling of heating can degrade the flavor and texture of food products.

Some food products are shelf stable at room temperature, such as canned products, which require a minimal amount of time to heat. However, the heat treatment required to make the food products stable degrades the flavor and texture.

It is an object of the present invention to provide gelled portioned frozen or cold stored food products and a method of preparing the portioned frozen or cold stored foods which do not require additional packaging necessary to separate the individual portions.

It is an object of the present invention to provide food products and a process of preparing food products quickly that have previously required long preparation and cook times.

It is a further object of the invention to provide food products and a process of preparing food products that will allow the thawing of frozen food products without the need for additional containers.

It is another object of the invention to provide food products that are controlled in size and shape, thus allowing for exact portion control.

It is yet another object of the invention to provide food products and a process of preparing food products in which food dehydration, freezer burn and moisture loss during refrigeration is reduced or inhibited.

### BRIEF SUMMARY OF THE INVENTION

The present invention is directed to a process for preparing non-shelf stable gelled food products comprising the steps of (a) preparing food materials and ingredients to form a food product; (b) preparing a gelling agent to form a gelling solution; (c) dipping the food product in the gelling solution, enrobing the food product with the gelling solution or adding the gelling solution to the food product; and (d) cooling the food product and gelling solution, wherein a gelled food product is formed.

The food materials include vegetables, potatoes, cooked and raw meat, cooked and raw poultry, cooked and raw fish, pasta, rice, grain products, fruits, and sauce, marinade and blended fruit drink ingredients.

The gelled food products include marinades, sauces, soups, chicken Alfredo, marinated raw beef steaks, broccoli florets in cheese sauce, potatoes O'Brien, french fried potatoes, pastas in sauces, rice dishes, risottos, breaded chicken nuggets, stuffing, fruit smoothies, salsas, desserts and appetisers.

The gelling agent includes gelling compounds comprising such as gelatin, pectin, guar gums, carrageenans, konjac, algin, alginates, agar, locust bean gum, acacia gum, methylcellulose gum, carboxymethylcellulose gum, gum arabic hydroxypropylmethylcellulose gum, microcrystalline cellulose gum, furcelleran gum, gellan gum, ghatti gum, karaya gum, tara gum, tragacanth gum, xanthan gum, other natural gums, native and modified starches, and combinations thereof.

The gelling agent is added to the food product in a range of 0.5% to 15.5% by weight.

The gelling agent formed from starches is added to the food product in a range of about 10 to 35% by weight.

The gelling agent formed from starches and other gelling compounds is added to the food product in a range of 5 to 25% by weight of starches and 0.1 to 5% by weight of the other gelling compounds.

The gelling agent comprises 2% gelatin and 0.05% carrageenan.

In the inventive process, the food products are non-shelf stable food products requiring refrigeration or freezing after forming.

The inventive process further includes the step of heating the food product for consumption, wherein during the heating step the gelling agent will melt at a temperature range of about 90 to 130° F.

The inventive process further includes the step of heating the food product for consumption, wherein during the heating step the gelling agent will destruct at a temperature range of about 140 to 175° F.

The process further includes the step of heating the gelled food product during final preparation of the product for consumption, wherein the heating step inhibits the gelled food product from re-gelling after final preparation, and before or during consumption of the food product.

The process further includes the step of adding a packeted enzyme to the gelling solution during preparation, wherein releasing of the packeted enzyme during final preparation of the food product inhibits the gelled food product from re-gelling after final preparation, and before or during consumption of the food product. The packeted enzyme is selected from a group consisting of bromelain, papin and combinations thereof.

Between 0.05% and less than 2% of a gelling agent is added to the food product in order to inhibit the gelled food product from re-gelling when mixed with other food products prior to consumption.

The process allows for gelled portion-controlled food products that provide a control system for measured amounts of food components selected from the group consisting of carbohydrates, fats, salt, protein, fiber, calcium and combinations thereof.

The gelling solution includes ingredients such as flavors, spices, fragrances, colorants, aromas, functional compounds, mycotics, heat sensitive colorants, flavor enhancement compounds, flavor masking compounds, vitamins, minerals, antioxidants, antimicrobials, heavy metal sequestrants, and combinations thereof.

The gelled food products can be frozen or refrigerated. The structure created by the gel is maintained when removed from frozen to refrigerated conditions. The benefits of thawing gelled food products include reduced cooking time, ease of handling due to structural integrity and protection of the flavor and texture of the food.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a flow diagram of one embodiment of the subject invention;

FIG. 2 is a flow diagram of an alternate embodiment of the subject invention;

FIG. 3 is a flow diagram of another alternate embodiment of the subject invention; and

FIG. 4 is a flow diagram of another alternate embodiment of the subject invention.

### DETAILED DESCRIPTION OF THE INVENTION

The subject invention is directed to non-shelf stable gelled food products such as gel enrobed, gel coated or gelled food products, a process for preparing the gelled food products, and a method of using the inventive food product. The technology of gelled foods has many benefits. The subject invention provides for improved food safety by providing a fully cooked or retorted food product that only requires minimal heating prior to eating. The enrobed and gel coated food products and the gelled food products reduce the need for expensive packaging. Further, the inventive gelled food products are not heat-treated after the gelling agent is added to the food product, thus requiring cold or frozen storage of the food product until it is prepared for consumption. In the present invention, all the gelled food products are preferably frozen or refrigerated. In the inventive process, heat is applied only to the gel solution when solubilizing the gel in order to maintain maximum product quality and freshness.

The invention further provides for enhanced food safety because gelled sauces are more resistant to product tampering (added liquids are visible) than liquid sauces. Gelled sauces are more difficult to adulterate because of the process of melting the gel, adding the adulterant, and reforming the gelled sauce or food. Gelled food products have better moisture retention, thus gelled steaks thawed and stored in a refrigerator exhibit reduced shrinkage, allowing for more product to be sold or eaten. Food quality is also maintained because food dehydration causes vitamin destruction, loss of water, soluble flavors, and food colors, resulting in unacceptable food products. Gelled foods resist dehydration, thus the quality of the food is retained for a longer period of time.

The shelf life of the enrobed or gel covered food products of the subject invention can be extended by the addition of antioxidants, antimicrobials or heavy metal sequestrants to the gel solution. Gelled food products provide for extended frozen or refrigerated shelf life because food nutrients are not lost through moisture drips. Gelled food products also provide for improved food handling. Gelled sauces and marinades do not flow therefore they can be handled and stored without a container, because gelled meats do not exhibit drip loss, cross-contamination of foods is reduced and food spoilage is minimized because bacteria do not have a nutritionally complete medium in which to grow.

The subject invention also provides for the controlled shape and size of food products. This in turn allows individual portion-control of food products that are prepared and served in the restaurant and commercial food industry and sold as retail products. It is known that diets high in fats, salt and carbohydrates pose health concerns because of weight gain (insulin spikes) and certain diseases (diabetes). There is currently no true control/measurement mechanism for carbohydrates, fats, salt, protein, fiber, calcium or other food components in food portions that are not sold as single servings. For example, a portioned box of rice, that when cooked, yields four servings does not provide “boundaries” of carbohydrate consumption unless one divides the cooked rice into the four individual servings. Normally, the portioned box of rice is cooked and consumers eat as much of the cooked rice as they desire. The consumer has no knowledge of how many ‘servings’ they consume and no measure of the consumed total carbohydrate, simple sugars versus complex sugars, or calorie intake. The present invention provides a carbohydrate counting/monitoring/control system as carbohydrate consumption from gelled foods can easily be monitored, measured and controlled because of the unique process of creating portion-controlled foods. This system would be viable for both retail and food service food products.

The aesthetics, such as color and plumpness, of gelled foods are improved over extended periods of frozen storage and freezer cycling versus conventional freezing methods such as Individually Quick Frozen (IQF) foods. Vitamin retention in gelled foods during frozen storage is improved versus conventional freezing methods such as those used to prepare Individually Quick Frozen foods. The food products of the subject invention will exhibit a better flavor profile than traditionally prepared convenience foods. In the inventive process, heat is applied only to the gel solution when solubilizing the gel which maintains maximum product quality and freshness of the food product.

The gel system does not inhibit the cooking process. Gel enrobed raw meat products can be subjected to cooking temperatures of up to 450° F. which typically produce an internal food temperature of about 145° F. The gelling agents typically degrade at temperatures above 200° F. In preparing fully cooked gelled food products for consumption, the foods only require reheating at a minimum temperature of about 120° F.

The gelled food products are preferably frozen or refrigerated after preparation and prior to consumption. The gel structure is maintained when the food products are removed from frozen to refrigerated conditions. The benefits of thawing gelled food products include reduced cooking time, ease of handling due to structural integrity of the gel and protection of the flavor and texture of the food.

The gelling agents used in the subject invention can also be utilized as carriers and a delivery system for functional ingredients that can be added to foods. The gelling agents can also be used as carriers of flavors, aromas, flavor enhancement and flavor masking agents, mycotics for use as shelf life extenders, heat sensitive colorants, and nutrient fortification and retention agents and other functional compounds.

Gel technology of the subject invention also allows for the invention of food products that are presently not possible with the application of current food technologies. The inventive gel technology and gelled food products also allow foods, not generally available in a fast-food environment, to be available to the general public. The gel technology of the present invention will enable restaurants to utilise flexible cooking methods and to quickly cook (generally 2 minutes or less) and serve high quality foods that have previously required long preparation and cook times such as risotto and steamed broccoli.

The inventive gel technology and gelled food products allow for the consumption of certain preparation intensive food products in non-traditional settings such as fast food dining, car drive-through eateries, casual eating, or cafeteria style food service eateries. Illustrative examples include gelled food products or gelled food components sold in vending machines without resultant sauce spillage; sleeves of various gelled sauces can be provided for mixing with cooked rice, allowing family members to choose their own flavor of rice; microwave safe cups with a platform and reservoir for use in steaming gelled vegetables in which the steaming gel collects in the cup reservoir and keeps the vegetables hot until eaten; and gelled nacho cheese pucks with a heated tube device for use in theatres and amusement parks. The gelled nacho cheese sauce puck falls by gravity through a heat tube, during the fall through the heated tube the nacho cheese puck melts and falls on the nacho chips as a sauce.

All types of food products can be enrobed, gel coated or gelled. Examples include but are not limited to, sauces and marinades of any type such as a balsamic vinegar marinade, salsas and sweet and sour sauce; soups; meats such as chicken Alfredo, and marinated raw beef steaks; vegetables such as green beans, carrots, broccoli florets and broccoli in cheese sauce; potatoes such as potatoes O'Brien and french fried potatoes; pastas, rices and risottos; deep fried meats such as breaded chicken nuggets; stuffing; fruits and fruit smoothies; desserts such as cheesecake and berry compote; appetisers; and complete meals such as sweet & sour chicken with rice or a roast beef dinner including sautéed onions, oven baked potato wedges and carrot crosscuts. Food materials used to form the food products include but are not limited to vegetables, cooked and raw meat, poultry and fish, starch ingredients such as pasta, rice, grain products, fruits, sauce and marinade ingredients, and blended fruit drink ingredients, all known to one skilled in the art of food preparation. The ratio of food to sauce is dependent on the application. In most instances, a one to one ratio will provide the desired result. A range of 5%-100% sauce can be used.

The enrobing, gel coating and gelling materials, generally referred to as gelling agents, can be used singly or in combination to produce the enrobed foods of the subject invention. A list of gelling agents includes at least the following compounds: gelatin, pectin, guar gums, carrageenans, konjac, algin, alginates, agar, locust bean gum, acacia gum, methylcellulose gum, carboxymethylcellulose gum, gum arabic hydroxypropylmethylcellulose gum, microcrystalline cellulose gum, furcelleran gum, gellan gum, ghatti gum, karaya gum, tara gum, tragacanth gum, xanthan gum, other natural gums, and native and modified starches.

The starches can be derived from a wide variety of plant sources including but not limited to potato, wheat, corn, tapioca, rice, and cassava. Starches can be used singly as gelling agents or in combination with other gels or gelling agents. Preferably, starches used singly require the addition of about 10%-35% starch by weight of the food (w/w) to create gelled foods. When starch is used in combinations with other gelling compounds to create gelled foods, the preferred combination will include starches in the range of about 5%-25% w/w and the other gelling compounds in the range of about 0.1%-5% w/w, forming a gelling agent added to the food product in a range of about 5.1%-30% w/w.

Gelling agents are typically solid at lower temperatures and liquid at higher temperature. Thus, one of the issues in adding gelling agents to food products, is the necessity of inhibiting prepared gelled food products from re-gelling on the consumer's plate. At least two methods can be used to inhibit the re-gelling of the prepared gelled food product, one is gel destruction and the other is gel dilution. Gel destruction can occur, for example, through the use of heat or the use of enzymes.

Starches such as potato starch can have its gelling properties fully or partially destroyed by high pressure and high temperature. If a pressure of about 16 psi and a temperature of about 116° C. is applied during a 30 minute cook period, the gelling properties of potato starch will be completely destroyed. Thus, the partial destruction of starch gels is possible during the final heating in the preparation of a gelled food product. A gelled food product using a starch, such as potato starch, as the gelling agent can be substantially inhibited from re-gelling by heating the food product for greater than 10 minutes during its preparation for consumption. The heating can be done by any means such as boiling, sautéing, baking, or broiling.

Enzymes known as proteases destroy gelatin gelling agents. Gelatin breakdown is susceptible to most proteases including bromelain and papain. The addition of carbohydrate packeted bromelain and papain to gelatin gelled food products will result in the breakdown of the gelatin during heating or cooking. Upon heating or cooking the gelled food product, the packets melt and release the enzymes into the gelled food product. Preferably, the enzyme packets contain about 0.5-5.0% of papain, bromelain, or a mixture of both enzymes. The enzyme concentration of this range is about 500-600 TU/mg (tyrosine units per milligram). For example, a recipe for a gelled food product containing packeted enzymes could include about 62% cooked rice, 25% water, 2% gelatin, 2% carrageenan, 3% bromelain, 3% papin and 3% gelatinase. The cooked rice is mixed with the other ingredients and then cooled to form a molded food product.

Alternatively, gelled food products can be inhibited from re-gelling by simple dilution of the gelling compounds. A first gelled food product can be produced that contains the minimum amount of gelling agents necessary to gel the food product such that the food product, when served with a second food product, results in the dilution of the gelling agent so that a continuous gel matrix cannot be formed. The second food product can be in the form of a topping, a partial topping or it can be mixed or blended into the first food product. For example, a parboiled cooked rice product gelled with 2% gelatin that is served by topping it with a sweet and sour sauce will not re-gel.

A preferred gelling system is one in which a mixture of 2% w/w gelatin and 0.05% w/w carrageenan results in a gelled food product that is thermoreversible. The food gelling system would melt at a temperature of 120° F. during the cooking of the food product and would re-gel gradually as the cooked food product cools from its final cook temperature of 165-180° F. to a cooled temperature of 70° F. At 70° F. the cooked food product would be completely re-gelled. Further, if the carrageenan concentration is held constant, then food products containing gelatin will perform as follows: foods containing more than 2% w/w gelatin form firm gels and foods containing less than 2% w/w gelatin do not gel. The inventive gelled food products are not heat-treated after the gelling agent is added to the food product, therefore, the gelled food product requires cold or frozen storage of the food product until it is prepared for consumption.

In the present invention, the more preferred method to inhibit re-gelling of a cooked food product is to dilute the gelatin concentration of the cooked food product to less than 2% by weight of the food. The food gelatin concentration can be diluted in a number of ways. For example, vegetables can be added to a gelled side dish, gelled entrée, etc.; a gravy or sauce can be added to or served over a gelled side dish, gelled entrée, etc; butter, sauce or gravy can be added to gelled vegetables; or a gelled entrée can be served over a non-gelled carbohydrate, etc.

The desired texture/strength/pliability of the gelled food product determines the percentage of gelling agent necessary to add to a particular food product For example, parboiled cooked rice will form a pliable gelled food when 1.5% w/w gelatin is added, a firm, rubbery texture when 5% w/w gelatin is added and a hard resilient texture when 10% w/w gelatin is added. In the present invention, a preferred amount is the addition of about 0.5%-15.5% w/w of gelling agents to any particular recipe in order to create the inventive gelled food product.

Generally, melting temperatures of the gelling agents can be achieved at about 90° to 130° F. When preparing raw meat items in a skillet or on a grill, the maximum surface temperature of the skillet or grill is about 350° F.-450° F., which will result in the degradation of the gelling agent. For food products fully cooked prior to gelling, heating temperatures from 140° F.-175° F. are generally sufficient for degradation of the gelling agent and for warming the food product prior to consumption.

Table 1 below illustrates ranges of time and temperature as related to gel melting and destruction verses food degradation (illustrated in Graph 1).

TABLE 1

| | Time | Temperature |
|---|---|---|
| Range for Gel Melting | 60 sec-2 min 30 sec | 90-130° F. |
| Range for Partial Destruction and | 2 min-4 min | 120-145° F. |
| Food Cook | | |
| Ideal Range for Gel Destruction | 3 min-5 min | 140-175° F. |
| Food Degradation | 5 min-7 min | 170-210° F. |

[image]

Illustrative examples of the time and temperature required to prepare certain gelled food products from a frozen state are listed in Table 2 below:

TABLE 2

| | | Sauce and raw | Sauce and cooked |
|---|---|---|---|
| | | vegetable (6-8 oz. | meat/raw meat (6-8 |
| | Sauce (6 oz.) | portion) | ounce portion) |
| Time at | 60 sec.-2 min. | 2-4 min. | 60 sec.-2 min. |
| ideal cook | preferred - | preferred - 3 min. | preferred - 90 sec. |
| temperature | 90 sec. | | |
| Total | 2-4 min. | 3-6 min. | 2-4 min. |
| cook time | preferred 2 | preferred - 4 min. | preferred 2 min. |
| | min. 30 sec. | | 30 sec. |
| Cook | 90-180° F. | 90-180° F. | 90-180° F. |
| temperature | preferred - | preferred - 145° F. | preferred - 145° F. |
| (Microwave | 145° F. | | |
| 1100 watts) | | | |

A further advantage of the addition of gel mixtures to food products is the alleviation of many food production issues. For example, mixture of 2% w/w gelatin and 0.5% w/w carrageenan solution added to parboiled cooked rice coats the rice and inhibits the rice/gel solution phase separation.

Flavorings and aromas can be added to the gelling agent for the purpose of odor destruction or aroma enhancement. For example a bacon flavoring and aroma can be added to gelled Brussel sprouts such that upon heating a bacon smell masks the naturally occurring sulfur smells of the cooked sprouts or Butter aroma can be added to gelled sweet corn such that upon heating and eating a butter aroma enhances the eating experience.

Mycotics (mold inhibitors) can be added to foods in order to extend shelf life. For example, natural cheese slices can be coated with a gelling agent containing potassium sorbate in order to prevent the natural cheese slices from molding. Food can be enrobed with a gelling agent containing heat sensitive colorants which are colorless but become colored if the food is temperature abused, thus providing a mechanism for food safety.

Flavor additions or enhancements can be added to food in the gelling agent. For example, gelled green peppers containing capsicum extract result in cooked peppers having a uniform heat intensity in taste, or carrot and celery sticks can be coated with chocolate flavored gel which will provide fun to eat foods. Lettuce can be enrobed in a nutrient fortified gel that includes ascorbic acid and mixed tocopherols in order to provide lettuce leaves with additional nutritional value.

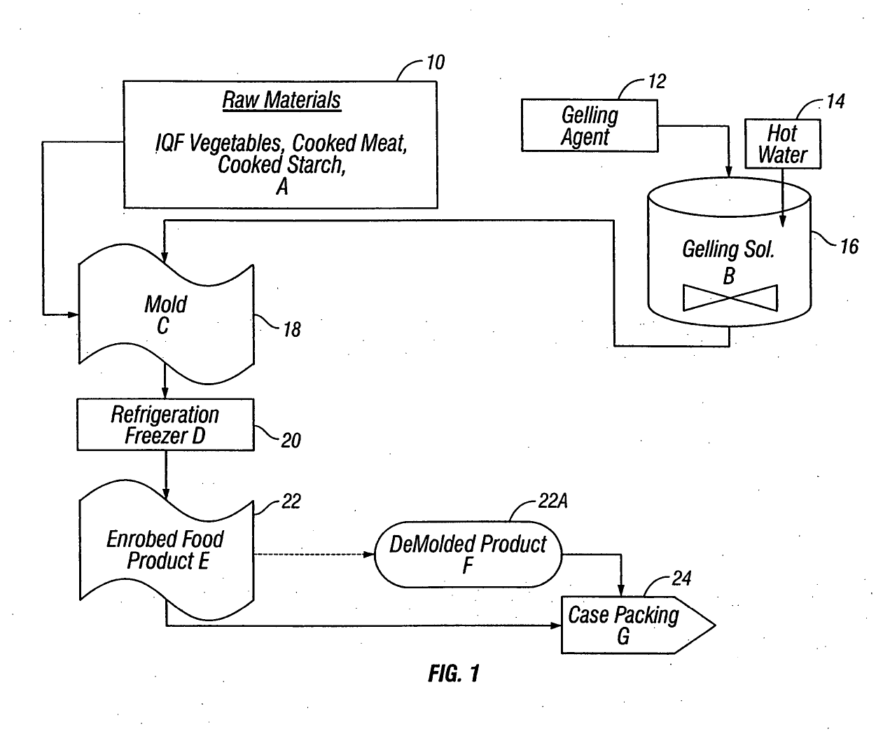

The enrobed, gel coated or gelled food products can be prepared by several different methods. A first method is preferably used to enrobe or embed solid foods 10 such as meat (raw, processed and/or cooked), vegetables (blanched and/or IQF) and so forth (FIG. 1). The first method includes several embodiments. A selected gelling agent 12 is solubilized in water 14 to create a mixture called a gelsol 16. A sufficient quantity of gelling agent 12 is used in the gelsol 16 such that over time the gelsol 16 will transform into a gel, which is defined as a jellylike substance formed by cooling a colloidal solution into a solid or semi-solid phase. The gelsol 16 can coat the food 10 with a thin coating or completely surround the entire food product with a layer of gel. In one embodiment, a container 18 (flexible or rigid mold) is selected in which to place the solid food 10 and the gelsol 16. The solid food 10 is placed into the container 18 and an appropriate amount of the gelsol 16 is poured over and around the food 10 to completely surround the food. The amount or thickness of gelsol 16 surrounding the solid food 10 will depend upon the food product being prepared. The gelsol 16 surrounding the solid food 10 becomes solidified at a temperature below the coagulation temperature of the particular gelling agent used to create the gelsol 16. This can take place at room temperature or in either a refrigeration or freezer unit 20. The enrobed or embedded solid food product 22 can remain in the container 18 or alternatively can be removed from the container 18 so as to create a demolded enrobed food product 22A, prior to packaging the enrobed or embedded food product 22, 22A in appropriate packaging 24. Thereafter the food product is cold or frozen stored until it is prepared for consumption.

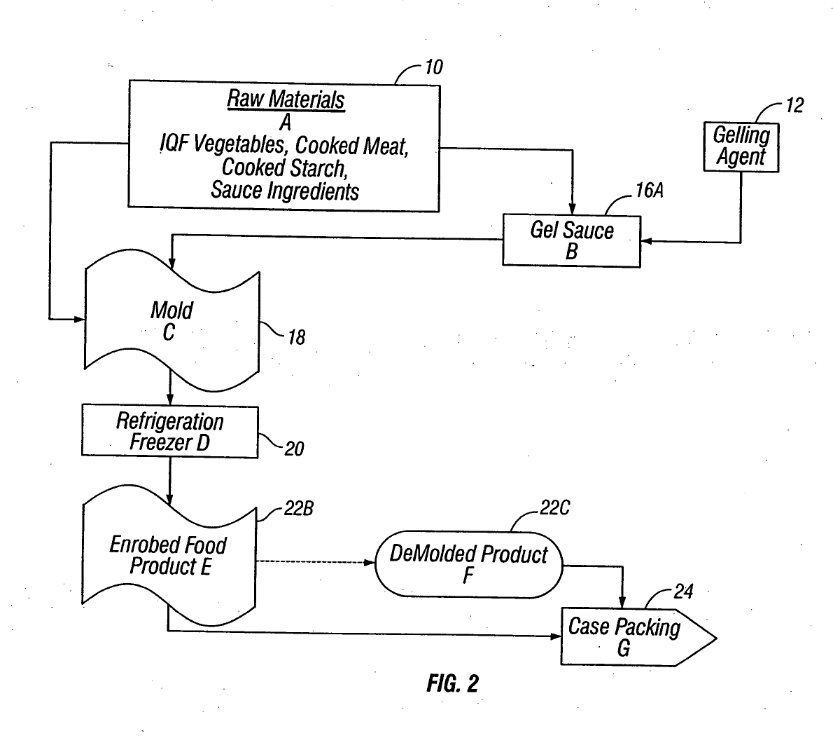

In a second embodiment a sufficient quantity of gelling agent 12 is dissolved in sauce ingredients to create a gel sauce 16A such that over time the gel sauce 16A will transform into a gel (FIG. 2). A container 18 (flexible or rigid) is selected in which to place the solid food 10 and the gel sauce 16A. The solid food 10 is placed into the container 18 and an appropriate amount of the gel sauce 16A is poured over and around the food 10 to completely surround the food. The amount and thickness of gel sauce 16A surrounding the solid food 10 will depend upon the food product being prepared. The gel sauce 16A surrounding the solid food 10 becomes solidified at a temperature below the coagulation temperature of the particular gelling agent used in the gel sauce 16A. This can take place at room temperature or in either a refrigeration or freezer unit 20. The enrobed or embedded solid food product 22B can remain in the container 18 or alternatively can be removed from the container 18 so as to create a demolded enrobed food product 22C, prior to packaging the enrobed or embedded food product 22B, 22C in appropriate packaging 24. Thereafter the food product is cold or frozen stored until it is prepared for consumption.

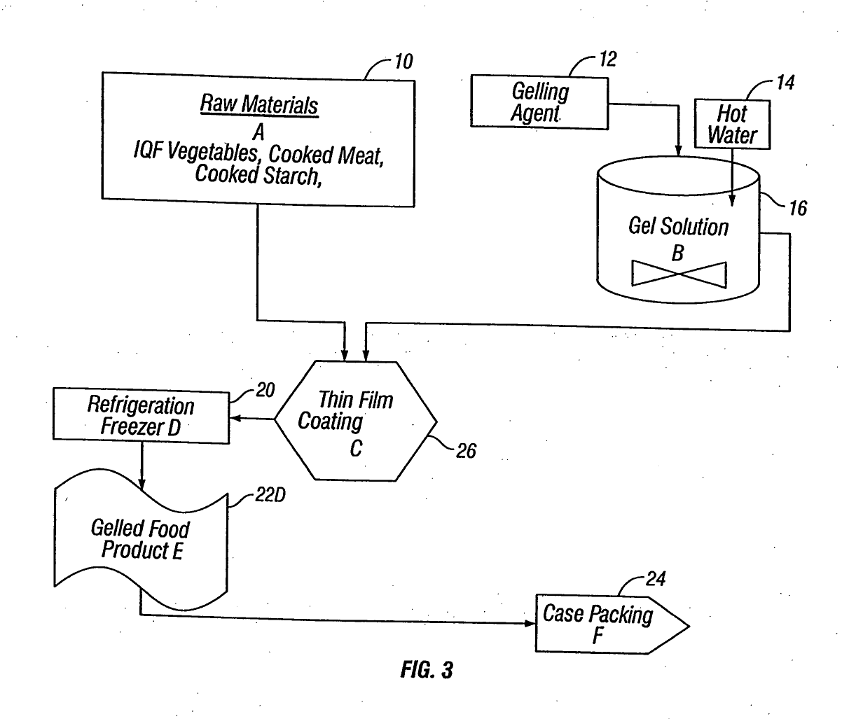

In a third embodiment of the first method, a vessel or other container 26 can be used in a thin film coating process in which a thin coating of a gelsol 16 is applied to the food product (FIG. 3). In one embodiment a “gelsol bath” is prepared in which a sufficient quantity of gelling agent 12 is used in the gelsol 16 such that over time the gelsol 16 will transform into a gel. The thin film coating processes can include dipping, conveying, or submerging the solid food 10 into the vessel 26 containing the gelsol 16, placing the solid food 10 in a thin film coating drum or spraying or foaming the gelsol 16 on the food product 10. The solid food product 10 is then removed from the thin film coating process in which the thin coating of gelsol 16 surrounding the solid food 10 becomes solidified at a temperature below the coagulation temperature of the particular gelling agent used in the gelsol bath. This can take place at room temperature or in either a refrigeration or freezer unit 20. The gel coated solid food 22D is then packaged in appropriate packaging 24. Thereafter the food product is cold or frozen stored until it is prepared for consumption.

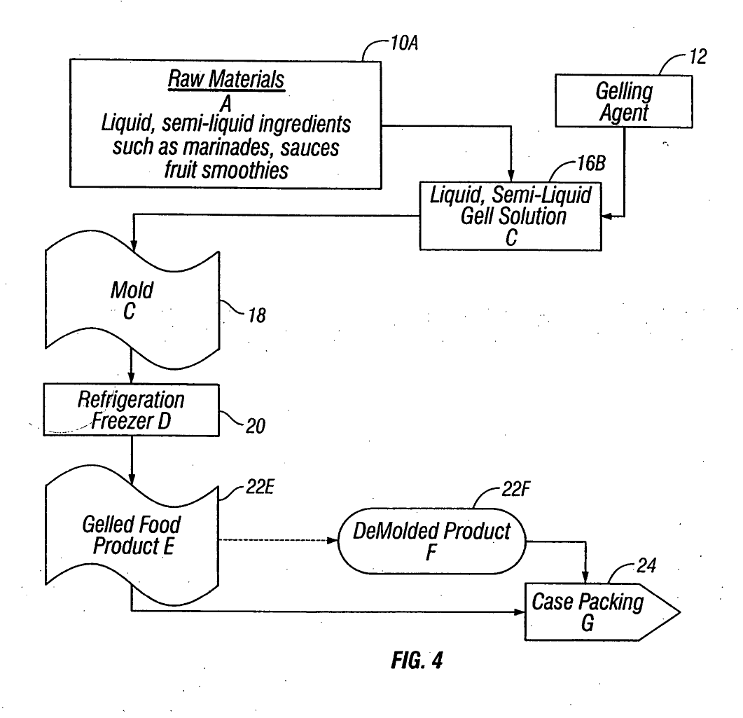

A second method is used to gel liquid or semi-solid (viscous) foods 10A such as marinades, sauces, fruit smoothies, and so forth (FIG. 4). In this method, a selected gelling agent 12 is mixed and solubilized into the matrix of the liquid or semi-solid food 10A creating a gel solution 16B. The gel solution 16B is placed in a container 18. The percentage of gelling agent 12 mixed into the food 10A is sufficient such that the food 10A will change into a gelled state after a short period of time at a temperature below the coagulation temperature of the particular gelling agent solubilized into the liquid or semi-liquid food 10A. This can take place at room temperature or in either a refrigeration or freezer unit 20. The gelled food product 22E can remain in the container 18 or alternatively can be removed from the container 18 so as to create a demolded gelled food product 22F, prior to packaging the gelled food product 22E, 22F in appropriate packaging 24. Thereafter the food product is cold or frozen stored until it is prepared for consumption.

When it is desired to prepare the enrobed or gel coated food product 22-22D for consumption, the enrobed or gel coated food product is heated to or above the melting temperature of the gelling agent, and depending upon the food product, it is then further heated to the proper temperature and served. The gelled enrobing gelsol or gel sauce becomes part of the served food product and as such it can be a carrier for ingredients such as flavors, spices, fragrances, colorants, or any other ingredient that can be dissolved in or mixed in with the gelling solution or sauce.

When it is desired to prepare the gelled liquid or semi-liquid food products 22E-F, the gelled food product is heated to or above the melting temperature of the gelling agent, and depending upon the food product, it is then served, used to prepare other foods or further heated to the proper temperature and served.

The enrobed, gel coated or gelled food products 22-22F allows frozen food products to be thawed without having to be placed in a container, because even thawed the enrobed, gel coated or gelled food product maintains its “gelled” state. The enrobing, coating or gelled material does not change from its “gelled” state until the food product is heated to or above the melting temperature of the particular gelling agent used in the enrobing or coating process.

### EXAMPLES

The following ingredient amounts and procedures are exemplary examples only of amounts and procedures that can be used to prepare the gelled food products of the subject invention.

### Example 1

For gelling liquid and or semi-solid (viscous) foods, 0.25 ounces of gelatin is solubilized into 6.0 ounces of a sweet & sour sauce. The sauce is cooled or frozen to form a solid “puck-like” form at room temperature. When it is desired to use the sauce in cooking, it can be heated in a pan and cooked with meat or poultry.

### Example 2

For gelling a liquid or semi-liquid (viscous) food such as a hot bacon dressing, during manufacturing of the bacon dressing, the recipe includes 4% gelatin. Upon cooling the dressing forms a solid “puck-like” form at room temperature. When it is desired to prepare the dressing for serving, the gelled puck of dressing is placed on, for example, a wilted spinach salad and is microwaved until the gel melts and the bacon dressing is hot (30-60 sec).

### Example 3

For enrobing or embedding a complete meal, 0.25 ounces of gelatin is solubilized into 6 ounces of water (gelsol). For example, 2 ounces of fully cooked meat plus 1 ounce gelsol, 2 ounces blanched broccoli plus 2 ounces gelsol, 2 oz blanched carrots plus 1 ounce gelsol and 2 oz sautéed mushrooms plus 2 ounces of gelsol are placed in a container or coated with the gelsol and then refrigerated or frozen. When the enrobed or gel coated food product is ready to prepare, it is placed in a microwave oven and heated until the food is hot.

### Example 4

For enrobing or embedding rice or pasta, 0.25 ounce of gelatin is solubilized into 6 ounces of chicken, beef, vegetable, or any other stock (gelstock). For example, 6 ounces of risotto plus 6 ounces of gelstock, or 6 ounces of cooked pasta plus 6 ounces of gelstock are placed in a container with the gelstock and then refrigerated or frozen. When the enrobed food product is ready to prepare, it is placed in a microwave oven and heated until the food is hot.

### Example 5

For enrobing or embedding solid foods and liquid or semi-solid (viscous) foods together, 0.25 ounces of gelatin is solubilized into 6 ounces of gravy (gelgravy). For example, a complete roast beef meal (4 ounces oven roasted beef, 3 ounces oven roasted potatoes, 1.50 ounces oven roasted carrots, 0.9 ounces oven roasted white onions enrobed with 4 ounces of gelgravy, 3.4 ounces oven roasted vegetables plus 2 ounces gelgravy and 4 ounces of oven roasted beef plus 2 ounces gelgravy are placed into a container and then refrigerated or frozen. When the enrobed food product is ready to prepare, it is placed in a microwave oven and heated until the food is hot.

### Example 6

For enrobing or embedding a stuffed food, such as baked stuffed pork chops, the raw pork chops are stuffed with stuffing (any stuffing that is desired) and baked in an oven until done. The baked stuffed pork chops are rapidly cooled in a cooler and then sprayed with a 4% solution of pork gravy/sauce flavored gelatin and frozen. When the pork chops are ready to prepare, the pork chops are reheated in a pan or microwave and the gelatin melts into a flavored sauce for the pork chop while the pork chop is being reheated.

### Example 7

For enrobing or embedding rice or pasta, such as a white wine parmesan risotto, 4% by weight of gelatin is added to a water/arborrio rice mixture prior to cooking and the arborrio rice is cooked via the risotto process. Upon cooling or freezing a gelled puck-shaped risotto product is formed. When the gelled puck-shaped risotto product is ready to serve, it is either microwaved for 1 minute or heated in a skillet containing chicken broth or another liquid and then served.

### Example 8

For enrobing or coating a solid food product such a steamed french cut green beans, french cut IGF green beans are enrobed or coated in a 4% solution of gelatin and then refrigerated or frozen. Upon heating the green beans in either a microwave or sauce pan, the gel solution melts and becomes the heating medium for the beans. Thereafter, the beans are drained of the gel fluid and served

### Example 9

For coating a solid food product such as a berry compote, fresh blackberries, blueberries and red raspberries are lightly sprayed with a 4% gelatin solution and thereafter cooled or frozen, resulting in individually gel coated berries. When ready to serve, the gel coated berries are spooned onto a scoop of ice cream, cake or such and microwaved for 15 seconds. The resulting food product is served as “fresh berries” over ice cream or cake.

### Example 10

For gelling a semi-liquid (viscous) food such as nacho cheese sauce, 4% gelatin is added to the nacho cheese sauce recipe during manufacturing of the sauce. Upon cooling the cheese sauce forms a solid “puck-like” shape at room temperature. When ready to serve, the gelled puck of nacho cheese sauce can be placed on chips and then microwaved until the gelled cheese sauce is melted and hot (30-60 sec).

### Example 11

For preparing a multi-component food product, only a portion of the food ingredients need to be enrobed. For example, in the preparation of “bread bowls”, the filling for the bread bowl, such as chicken salad, is enrobed in a gel sauce and placed into a hollowed out loaf of bread. The bread bowl is thereafter packaged and frozen. When ready to serve, the bread bowl is microwaved until the gel sauce has melted and the filling is heated to an appropriate temperature. Due to the enrobing of the filling ingredients, the bread portion of the product does not experience the moisture of the food filling until reheated and therefore does not become soggy during production, distribution and storage.

One embodiment of the process of enrobing or embedding a solid food as illustrated in FIG. 1 includes the following steps:

A. Food materials 10 such as IQF vegetables, cooked meats, or cooked starch ingredients are prepared;

B. A gelling agent 12 is dissolved in hot water 14 to create a gel solution 16;

C. The food product 10 and the gel solution 16 is placed into a mold 18;

D. The food product 10 and gel solution 16 is cooled to a congealed state at room temperature or placed in a freezer or refrigeration unit 20;

E. The enrobed or embeded food product 22 is removed from the freezer or refrigeration unit 20, alternatively

F. The enrobed or embedded product 22A is removed from the freezer or refrigeration unit and demolded;

G. The enrobed or embedded food product 22, 22A is packaged 24 for shipping and sale.

A second embodiment of the process of enrobing or embedding a solid food and sauce as illustrated in FIG. 2 includes the following steps:

A. Food materials 10 such as IQF vegetables cooked meats, or cooked starch, and sauce ingredients are prepared;

B. A gelling agent 12 is dissolved in the sauce ingredients 10 to create a gel sauce 16A;

C. The food products 10 and the gel sauce 16A is placed into a mold 18;

D. The food product and sauce is cooled to a congealed state at room temperature or in a freezer or refrigeration unit 20;

E. The enrobed or embedded food product 22B is removed from the freezer or refrigeration unit; alternatively

F. The enrobed or embedded food product 22C is removed from the freezer or refrigeration unit 20 and demolded;

G. The enrobed or embedded food product 22B, 22C is packaged 24 for shipping and sale.

A third embodiment of the process of gel coating a solid food as illustrated in FIG. 3 includes the following steps:

A. Food materials 10 such as IQF vegetables, cooked meats or cooked starch ingredients are prepared;

B. A gelling agent 12 is dissolved in hot water 14 to create a gel solution 16;

C. The food products 10 is gel coated with the gel solution 16 in a thin film coating process in vessel 26;

D. The gel-coated product 22D is cooled to a congealed state at room temperature or in a freezer or refrigeration unit 20;

E. The gel-coated product 22D is packaged 24 for shipping and sale.

A fourth embodiment of the process of gelling a liquid or semi-liquid food product as illustrated in FIG. 4 includes the following steps:

A. Liquid or semi-liquid food materials 10A such as marinades, sauces or fruit smoothies are prepared;

B. A gelling agent 12 is dissolved in the liquid or semi-liquid food materials 10A to create a gel solution 16B;

C. The gel solution 16B is placed into a mold 18;

D. The gel solution 16B is cooled to a congealed state at room temperature or in a freezer or refrigeration unit 20;

E. The gelled food product 22E is removed from the freezer or refrigeration unit 20; alternatively

F. The gelled food 22F product is removed from the freezer or refrigeration unit 20 and demolded;

H. The gelled food product 22E, 22F is packaged 24 for shipping and sale.

### Example 12

For preparing a converted brand rice dish the following recipe can be used:

| Rice Ingredients | Percent |
|---|---|
| Water | 60.00% |
| Rice, Long Grain, Parboiled | 40.00% |
| Cooked Rice Total | 100.00% |

Rice is cooked on the stove top for about 16 minutes.

| Sauce Ingredients | Percent |
|---|---|
| Water | 92.31% |
| Gelatin | 7.50% |
| Carrageenan | 0.19% |
| Total | 100.00% |

Sauce Preparation Procedure:

1. Blend gelatin and carrageenan.

2. Measure water.

3. Add dry Ingredient. Heat to 165° F.

4. Check for viscosity.

4. Maintain temperature at 145° F. or more.

| Filling Blend Ingredients | Percent |
|---|---|
| Cooked Rice | 73.33% |
| Sauce —Gel Solution | 26.67% |
| Filling Blend Total | 100.00% |

Blend cooked rice and sauce together for a finished product and place the product in a container or mold. The product is then cooled to a temperature below the coagulation temperature of the gelling agent.

### Example 13

For preparing a one step Mexican Rice dish the following recipe can be used:

| Rice Ingredients | Percent |
|---|---|
| Water | 60.00% |
| Rice, Long Grain, Parboiled | 40.00% |
| Cooked Rice Total | 100.00% |

Rice is cooked on the stove top for about 16 minutes.

| Mex. Gel Sauce Ingredients | Percent |
|---|---|
| Water | 70.68% |
| Gelatin | 5.59% |
| Carrageenan | 0.14% |
| Chicken Base | 6.50% |
| Spanish Powder PMX | 5.80% |
| Tomato Paste 31% Solids | 7.08% |
| Spices and Seasonings | 4.21% |
| Sauce Total | 100.00% |

Sauce Preparation Procedure:

1. Blend all dry Ingredients.

2. Measure water.

3. Stir in tomato paste and chicken base.

4. Add dry Ingredient. Heat to 165° F.

5. Check for viscosity.

6. Maintain temperature at 145° or more.

| Filling Bland Ingredients | Percent |
|---|---|
| Cooked Rice | 47.50% |
| IQF Diced Onion | 2.45% |
| IQF Green Bell Pepper Strips | 4.29% |
| Canned, Drained Pinto Beans | 9.80% |
| IQF Cilantro | 0.12% |
| Mex Sauce/Gel Solution | 35.83% |
| Filling Blend Total | 100.00% |

Blend cooked rice, sauce and other ingredients together for finished product and place the product in a container or mold. The product is then cooled to a temperature below the coagulation temperature of the gelling agent.

### Example 14

For preparing a one step long grain and wild rice dish the following recipe can be used:

| Long grain rice Ingredients | Percent |
|---|---|
| Water | 60.00% |
| Rice, Long Grain, Parboiled | 40.00% |
| Cooked Rice Total | 100.00% |

Rice is cooked on the stove top for about 16 minutes.

| Wild rice Ingredients | Percent |
|---|---|
| Water | 55.00% |
| Wild Rice | 45.00% |
| Cooked Rice Total | 100.00% |

Rice is cooked on the stove top for about 20 minutes.

| Sauce Ingredients | Percent |
|---|---|
| Water | 81.40% |
| Gelatin | 6.00% |
| Carrageenan | 0.15% |
| Spice Premix | 9.08% |
| Dehy. Onions, White Chopped | 1.84% |
| Parsley Flaked (N/S) | 0.99% |
| Spinach Flakes Unsulfited | 0.49% |
| Celery Stalk and Leaf Flakes | 0.05% |
| Sauce Total | 100.00% |

Sauce Preparation Procedure:

1. Blend all dry Ingredients.

2. Measure water.

3. Add dry Ingredient. Heat to 165° F.

4. Check for viscosity.

5. Maintain temperature at 145° F. or more.

| Filling Blend Ingredients | Percent |
|---|---|
| Cooked Long grain rice | 54.67% |
| Cooked Wild Rice | 4.17% |
| IQF Onion | 2.61% |
| IQF Celery | 2.23% |
| IQF Diced Carrot | 3.00% |
| LG&W Sauce/Gel Solution | 33.33% |
| Filling Blend Total | 100.00% |

Blend cooked rice, sauce and other ingredients together for finished product and place the product in a container or mold. The product is then cooled to a temperature below the coagulation temperature of the gelling agent.

### Example 15

For preparing a one step rice pilaf dish the following recipe can be used:

| Long grain rice Ingredients | Percent |
|---|---|
| Water | 60.00% |
| Rice, Long Grain, Parboiled | 40.00% |
| Cooked Rice Total | 100.00% |

Rice is cooked on the stove top for about 16 minutes.

| Pasta Ingredients | Percent |
|---|---|
| Hot Water | 52.93% |
| Toasted Orzo | 47.07% |
| Cooked Total | 100.00% |

The orzo is toasted in a pan until slightly brown, the water is added and the orzo is cooked until the water has evaporated.

| Sauce Ingredients | Percent |
|---|---|
| Water | 81.00% |
| Gelatin | 10.00% |
| Carrageenan | 0.25% |
| Chicken Base | 3.00% |
| HPP Enhancer | 1.43% |
| Salt | 1.67% |
| Sugar | 1.05% |
| Spices and Seasonings | 0.86% |
| Sauce Total | 100.00% |

Sauce Preparation Procedure:

1. Blend all dry ingredients

2. Measure water.

3. Stir in chicken base.

4. Add dry ingredients. Heat to 165° F.

5. Check for viscosity.

6. Maintain temperature at 145° F. or more.

| Filling Blend Ingredients | Percent |
|---|---|
| Cooked Rice | 56.6% |
| Hydrated Toasted Orzo | 10.83% |
| IQF Diced Onions | 4.17% |
| IQF Shoestring Carrots | 4.17% |
| IQF Celery Slice | 4.17% |
| Pilaf Sauce/Gel Solution | 20.00% |
| Filling Blend Total | 100.00% |

Blend the rice, orzo and other ingredients together for finished product and place the product in a container or mold. The product is then cooled to a temperature below the coagulation temperature of the gelling agent.

### Example 16

For a one step risotto dish the following recipe can be used:

| Rice Ingredients | Percent |
|---|---|
| Water | 60.00% |
| Rice, Medium Grain, Milled | 40.00% |
| Cooked Rice Total | 100.00% |

Rice is cooked on the stove top for about 14 minutes.

| Sauce Ingredients | Percent |
|---|---|
| Water | 48.18% |
| Gelatin | 6.00% |
| Carrageenan | 0.15% |
| Butter | 5.11% |
| Cream Powder | 5.30% |
| Nonfat Dry Milk | 10.55% |
| Dry White Wine | 15.00% |
| IQF Diced Onion | 8.00% |
| Starch | 0.50% |
| Natural Chicken Flavor | 1.20% |
| Sauce Total | 100.00% |

Sauce Preparation Procedure:

1. Combine dry ingredients.

2. Melt butter. Add onion, stir and heat until onion is translucent.

3. Add water.

4. Add dry ingredients. Heat until 165° F.

5. Add white wine.

6. Check for viscosity.

7. Maintain temperature at 145° F. or more.

| Filling Blend Ingredients | Percent |
|---|---|
| Cooked Medium Rice | 66.67% |
| Pilaf Sauce/Gel Solution | 33.33% |
| Filling Blend Total | 100.00% |

Blend the rice and sauce together for finished product and place the product in a container or mold. The product is then cooled to a temperature below the coagulation temperature of the gelling agent.

### Example 17

For a one step stuffing dish, the following recipe can be used:

| Stuffing Ingredients | Percent |
|---|---|
| Water | 50.68% |
| Butter | 8.26% |
| Spice PMX | 4.77% |
| IQF Diced Onions | 2.16% |
| IQF Diced Celery Slice | 4.84% |
| Gelatin | 2.00% |
| Carrageenan | 0.05% |
| Bread Crumbs | 27.24% |
| Filling Blend Total | 100.00% |

Preparation Procedure:

1. Combine dry ingredients.

2. Melt butter. Add onion and celery, stir and heat until onion is translucent.

3. Add water.

4. Add dry ingredients except breadcrumbs. Heat until 165° F.,

5. Blend in breadcrumbs.

6. Maintain temperature at 145° F. or more.

7. Place the product in a container or mold.

8. The product is then cooled to a temperature below the coagulation temperature of the gelling agent.

The present invention provides food products and a process of preparing food products quickly that have previously required long preparation and cook times. It also allows the thawing of frozen food products without the need for additional containers. The present invention further provides food products and a process of preparing food products in which food dehydration, freezer burn and moisture loss during refrigeration is reduced or inhibited.

The present invention allows restaurants to prepare and serve food products quickly, generally 2 minutes or less, that have previously required long preparation and cook times. Thus allowing food serve operations to reduce labor costs, reduce the skill level of the kitchen staff, serve food items not previously possible, and reduce the wait time of customers.

The present invention further provides for the controlled size and shape of prepared food products which in turn allows for individual portion control. This will provide for a consistent quality of food products and a known cost and size of individual food portions for the restaurant and commercial food industry.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A process for preparing gelled food products comprising the steps of:
(a) preparing food materials and ingredients to form a food product;
(b) preparing a gelling agent to form a gelling solution;
(c) dipping the food product in the gelling solution, enrobing the food product with the gelling solution or adding the gelling solution to the food product; and
(d) cooling the food product and gelling solution, wherein a gelled food product is formed.

2. The process of claim 1, wherein the gelling agent is selected from the group of gelling compounds consisting of gelatin, pectin, guar gums, carrageenans, konjac, algin, alginates, agar, locust bean gum, acacia gum, methylcellulose gum, carboxymethylcellulose gum, gum arabic hydroxypropylmethylcellulose gum, microcrystalline cellulose gum, furcelleran gum, gellan gum, ghatti gum, karaya gum, tara gum, tragacanth gum, xanthan gum, other natural gums, native and modified starches, and combinations thereof.

3. The process of claim 1, wherein the gelling agent is added to the food product in a range of 0.5% to 15.5% by weight.

4. The process of claim 2, wherein a gelling agent formed from starches is added to the food product in a range of about 10 to 35% by weight.

5. The process of claim 2, wherein a gelling agent formed from starches and other gelling compounds is added to the food product in a range of 5 to 25% by weight of starches and 0.1 to 5% by weight of the other gelling compounds.

6. The process of claim 2, wherein the gelling agent comprises 2% gelatin and 0.05% carrageenan.

7. The process of claim 1, further including the step of heating the gelled food product during final preparation of the product for consumption, wherein the heating step inhibits the gelled food product from re-gelling after final preparation, and before or during consumption of the food product.

8. The process of claim 7, wherein the gelled food product is heated for more than 10 minutes.

9. The process of claim 1, further including the step of adding a packeted enzyme to the gelling solution during preparation, wherein releasing of the packeted enzyme during final preparation of the food product inhibits the gelled food product from re-gelling after final preparation, and before or during consumption of the food product.

10. The process of claim 9, wherein the packeted enzyme is selected from a group consisting of bromelain, papin and combinations thereof.

11. The process of claim 1, wherein between 0.05% to less than 2% of a gelling agent is added to the food product in order to inhibit the gelled food product from re-gelling when mixed with other food products prior to consumption.

12. The process of claim 1, wherein the gelling solution further includes ingredients selected from the group consisting of flavors, spices, fragrances, colorants, aromas, functional compounds, mycotics, heat sensitive colorants, flavor enhancement compounds, flavor masking compounds, flavor altering compounds, vitamins, minerals, antioxidants, antimicrobials, heavy metal sequestrants, and combinations thereof.

13. The process of claim 1, further including the steps of:
e) placing the food product into a container or mold prior to the cooling step;
f) removing the gelled food product from the container or mold after the cooling step;
whereby the demolded gelled food product forms a portion-controlled food product.

14. The process of claim 13, wherein the gelled portion-controlled food product provides a control system for measured amounts of food components selected from the group consisting of carbohydrates, fats, salt, protein, fiber, calcium and combinations thereof.

15. The process of claim 1, wherein the food materials are selected from the group consisting of vegetables, potatoes, cooked meat, raw meat, cooked poultry, raw poultry, cooked fish, raw fish, pasta, rice, grain products, fruits, and sauce, marinade and blended fruit drink ingredients.

16. The process of claim 1, wherein the food products are selected from the group consisting of marinades, sauces, soups, chicken Alfredo, marinated raw beef steaks, broccoli florets in cheese sauce, potatoes O'Brien, french fried potatoes, pastas in sauces, rice dishes, risottos, breaded chicken nuggets, stuffing, fruit smoothies, salsas, desserts and appetisers.

17. The process of claim 1, wherein the food products are non-shelf stable food products requiring refrigeration or freezing after forming.

18. The process of claim 1, further including the step of heating the food product for consumption, wherein during the heating step the gelling agent will melt at a temperature range of about 90 to 130° F.

19. The process of claim 1, further including the step of heating the food product for consumption, wherein during the heating step the gelling agent will destruct at a temperature range of about 140 to 175° F.

20. A gelled food product produced by a process comprising the steps of:
(a) preparing food materials and ingredients to form a food product;
(b) preparing a gelling agent to form a gelling solution;
(c) dipping the food product in the gelling solution, enrobing the food product with the gelling solution or adding the gelling solution to the food product; and
(d) cooling the food product and gelling solution, wherein a gelled food product is formed.

21. The food product of claim 20, wherein the gelled food product is selected from a group consisting of enrobed food products, gel coated food products and liquid or semi-liquid food products containing a gelling agent.

22. The food product of claim 20, wherein the a ratio of a sauce food product to the food product is in the range of about 5% to 100% sauce.

23. A method of preparing a gelled food product, comprising the steps of:
a) heating the gelled food product to a selected temperature by means of a heating source;
b) removing the food product from the heating source and serving the food product.

24. The method of claim 23, further including the steps of:
c) adding other food products to the gelled food product after the first heating step; and
d) heating the gelled food product and the other food product by means of the heating source for a selected period of time to form a combined food product.
